(19) United States
(12) Patent Application Publication
(10) Pub. No.: US 2025/0360956 A1
(43) Pub. Date: Nov. 27, 2025

(54) Integrated Pallet Jack Fork Tip Bracket

(71) Applicant: Carlos Martir, Brandon, FL (US)

(72) Inventor: Carlos Martir, Brandon, FL (US)

(21) Appl. No.: 19/287,073

(22) Filed: Jul. 31, 2025

(51) Int. Cl. B62B 3/06; B62B 3/10

(52) U.S. Cl. CPC B62B 3/0612; B62B 3/10

(57) ABSTRACT

A bracket system for electric pallet jacks includes structural components affixed to the fork tips, each bracket comprising either a unitary structure or a joined assembly of a horizontal plate and vertical riser. The system facilitates side-entry engagement of standardized pallets by aligning with lateral notches located on the 48-inch side. The brackets incorporate features configured to reduce pallet slippage and enhance handling stability. The system supports both original equipment manufacture and retrofit integration without interfering with standard forward pallet access.

The invention relates to material handling systems and, more specifically, to electric pallet jacks incorporating fixed fork-tip brackets designed to engage standardized 48×40-inch pallets via the notches located on the 48-inch side.

Conventional pallet jacks engage pallets from the 40-inch side, which may limit maneuverability in narrow or congested spaces. Existing removable side-lift accessories are often structurally inconsistent or require manual installation. The present invention addresses these issues by providing a bracket system directly affixed to the fork tips for consistent side-entry access.

One known prior system, U.S. Pat. No. 6,028,628 (now expired), discloses a detachable side-lift apparatus that enables lateral engagement with pallets. However, the device requires manual installation and removal and obstructs standard forward engagement with the 40-inch side of a pallet. In contrast, the present invention provides a fixed bracket system that is permanently affixed or integrated into the pallet jack's fork tips, thereby enabling seamless lateral access without interfering with standard forward pallet handling operations.

The horizontal portion of each bracket may incorporate features such as lips, hooks, or raised elements that interface with lateral notches on a pallet. These features improve alignment, prevent rollback, and support consistent pallet engagement.

Each bracket may be formed from durable materials including hardened steel or comparable industrial alloys. The brackets may be welded to or integrally formed with the fork tips, ensuring secure alignment while preserving the forward entry function.

The bracket system may be integrated during original equipment manufacture or provided as a retrofit solution using alignment tools, weld guides, or fastening hardware.

Benefits of the system include improved lateral pallet access, enhanced operator control, and elimination of cumbersome side entry attachments. The design supports both reliability and safety in high-density warehouse environments.

Referenced figures illustrate structural profiles, notch interfaces, weld zones, and the spatial configuration of the bracket relative to pallet notches and fork tips under operating conditions.

The design achieves dual compatibility-enabling side-entry access while preserving standard forward entry-thereby increasing pallet jack versatility without increasing operational complexity.

The bracket system may be adjustable in its placement and alignment along the fork tip to accommodate variations in pallet notch positioning among different OEM pallet jack brands and models. This adjustability ensures consistent engagement with standardized notches on the 48-inch side of the pallet while maintaining compatibility with manufacturer-specific fork geometries.

As used herein, “unitary” or “monolithic” refers to a structure formed from a single piece of material, whether by molding, forging, or machining. “Bracket” refers to either a unitary or a multi-piece component attached or integrated with the pallet jack fork tip. “Notch engagement” refers to physical interaction between the bracket and a recessed feature on a standard 48×40-inch pallet sufficient to prevent backward movement during lifting or dragging.

### BRIEF DESCRIPTION OF THE DRAWINGS

FIG. 1 is a side elevation view showing bracket shape and notch interface.

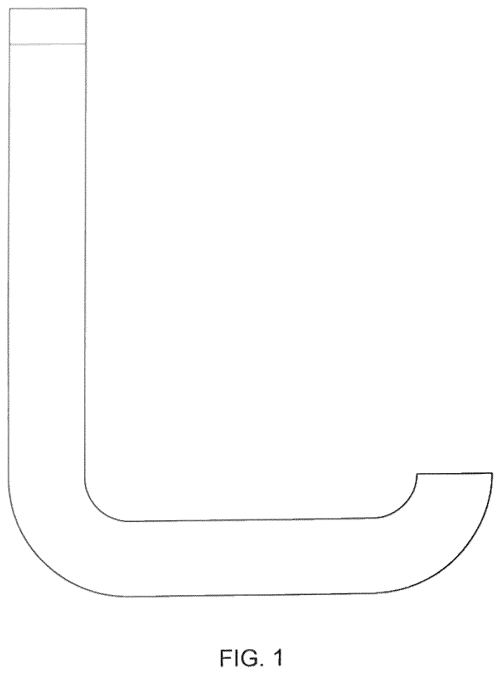

FIG. 2 is a top-front perspective illustrating bracket alignment.

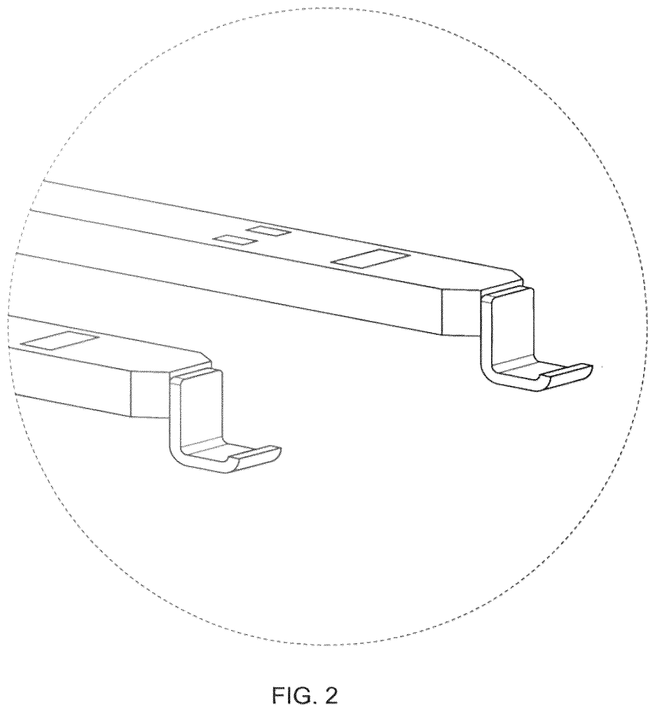

FIG. 3 is a rear view showing weld zones.

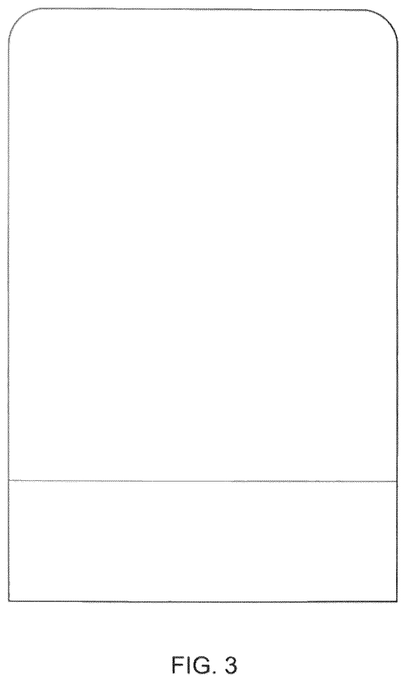

FIG. 4 is a lateral use example.

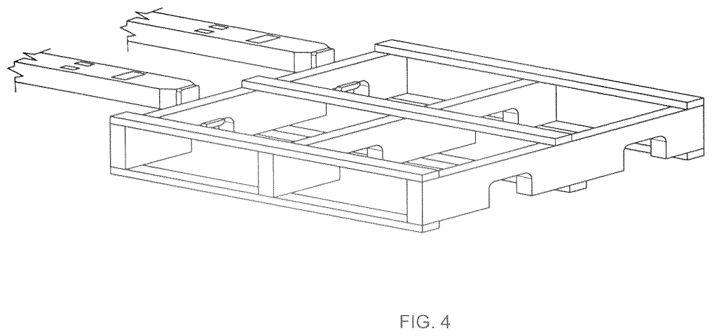

FIG. 5 is an exploded view of bracket-fork-pallet relationship.

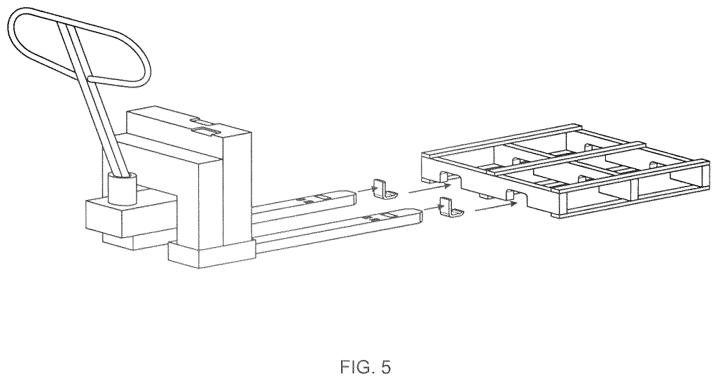

The bracket system is designed to engage and tilt a pallet laterally, rather than lift it vertically. This functionality enables operators to pull or push pallets into the rear of trucks, trailers, or tightly packed warehouse areas where traditional lifting access is restricted. By facilitating precise pallet positioning without lifting, the system enhances maneuverability and space utilization, particularly in narrow aisle environments and during back-of-truck loading and unloading operations.

1. A bracket system for an electric pallet jack, comprising: a. a pair of brackets, each attached to a forward tip of a corresponding fork; b, wherein each bracket comprises either: i. a unitary structure defining a substantially L-shaped configuration, or ii. an assembly including a horizontal plate and a vertical riser joined at a defined angle; c, wherein the horizontal plate comprises a raised lip formed integrally with the horizontal plate, the lip being configured to engage a lateral notch of a standardized wooden pallet; d, wherein the bracket is configured to secure to and align with a pallet having a 48×40-inch dimension with notches on the 48-inch side; e, wherein the bracket system allows lateral engagement without preventing forward engagement from the 40-inch side; f, wherein the bracket configuration is adapted to maintain proper orientation relative to pallet geometry during operation.

2. The bracket system of claim 1, wherein the horizontal plate includes a raised edge configured to interface with the lateral notch of a pallet and prevent rollback during lateral movement.

3. The bracket system of claim 1, wherein each bracket is attached to the fork tip using a welded or molded joint that maintains fixed alignment under load.

4. The bracket system of claim 1, wherein each bracket is formed from a hardened steel or industrial alloy and configured to withstand repeated side-entry engagements.

5. The bracket system of claim 1, wherein the brackets are retrofittable to existing electric pallet jack forks using weld guides or fastening hardware.

6. The bracket system of claim 1, wherein each bracket is positioned during installation at a selectable location along the fork tip to match the notch position of a corresponding pallet, the adjustment being achieved through weld placement or bracket length customization, without post-installation movement.

7. A method of laterally engaging and maneuvering a standardized wooden pallet using an electric pallet jack, the method comprising: a. positioning the pallet jack forks such that brackets affixed to the forward fork tips align with notches on the 48-inch side of a 48×40 wooden pallet; b. inserting the bracket's horizontal plate into the lateral notches of the pallet; c. engaging the notches with a raised lip, hook, or contoured feature on the horizontal plate to prevent rollback; d. dragging or guiding the pallet laterally without requiring vertical lifting of the pallet; e. and withdrawing the pallet jack while maintaining bracket orientation and alignment with the pallet's notch structure.

8. The method of claim 7, wherein the brackets are permanently affixed by welding or molding to the fork tips of the pallet jack.

9. The method of claim 7, wherein the brackets facilitate precision alignment of the pallet within a confined area, such as a trailer or narrow aisle, without requiring physical contact between the pallet and surrounding structures.

10. The method of claim 7, wherein the bracket's engagement with the pallet notch is configured to maintain contact under inclined or uneven flooring conditions to prevent slippage.
